(19) United States
(12) Patent Application Publication
(10) Pub. No.: US 2011/0145746 A1
(43) Pub. Date: Jun. 16, 2011

(54) METHOD, APPARATUS, AND COMPUTER PROGRAM PRODUCT FOR GENERATING AUDIBLE ALERTS

(76) Inventors: James Malnati, Stillwater, MN (US); Robert Jamieson, Kuala Lumpur (MY)

(21) Appl. No.: 12/637,928

(22) Filed: Dec. 15, 2009

(51) Int. Cl. G08B 21/00; G06F 3/048

(52) U.S. Cl. 715/771; 340/540

(57) ABSTRACT

A method for managing alerts in a distributed computer system includes monitoring one or more portions of the computer system for exceptions and, upon discerning a first exception, generating an audible alert at a first workstation of the computer system. A distributed computer system includes at least one workstation and at least one component executing a system event detection program. The computer system further includes a first module that monitors the computer system for a system event requiring administrative attention and a second module that produces an audible alert of the system event on a first workstation. A computer program product has a computer readable medium that has computer program logic recorded thereon for providing audible alerts for conditions of a distributed computer system. The computer program product includes code for discerning a system condition requiring administrative attention and code for generating an audible alert to a first workstation of the distributed computer system in response to discerning the system condition.

### TECHNICAL FIELD

The present disclosure relates to audible alerts for system conditions in computer systems. More specifically, the present disclosure relates to audible alerts in large distributed computing systems.

### BACKGROUND

Information technology systems are essential to any modern business. These systems have grown more and more complex. Today they can include distributed centers located anywhere from a few miles apart to those across the continent or in separate countries. Today, personal computers are common and many businesses employ multiple operating systems from various vendors. Often systems are dispersed in branch offices running critical applications or containing essential data.

Tools are available that integrate operational control of multiple heterogeneous mainframes and distributed systems. In one example, an alert notification program monitors the system for conditions that require attention, such as a disk drive reaching maximum capacity or other operational exception. In prior art systems, the alert notification program runs on a server that monitors a managed computer system. When an exception is detected on the managed system, the alert notification program generates a visual alert on the Graphical User Interface (GUI) at the server. The alert notification program may also be configured to perform external actions, such as sending an email and/or text message. An attendant can then act on the alert by acknowledging and/or clearing the alert. One disadvantage of visible alerts is that they may not be effective if the attendant is not at the workstation or if the attendant is not looking at the particular window with the alert GUI. Email and or text notifications may also lack effectiveness if the attendant is not checking a device for emails and text messages. For these and other reasons, improvements are desirable.

### SUMMARY

In accordance with the following disclosure, the above and other problems are solved by the following:

### BRIEF DESCRIPTION OF THE DRAWINGS

FIG. 1 is a block diagram of an operational system for managing a large distributed computing system;

FIG. 2 is an illustration of an exemplary GUI for use with a system providing audible alerts adapted according to one embodiment;

FIG. 3 is an illustration of an exemplary GUI for use with a system providing audible alerts adapted according to one embodiment; and

FIG. 4 is an operational flow diagram illustrating an exemplary method of generating and managing alerts for a large distributed computing system.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

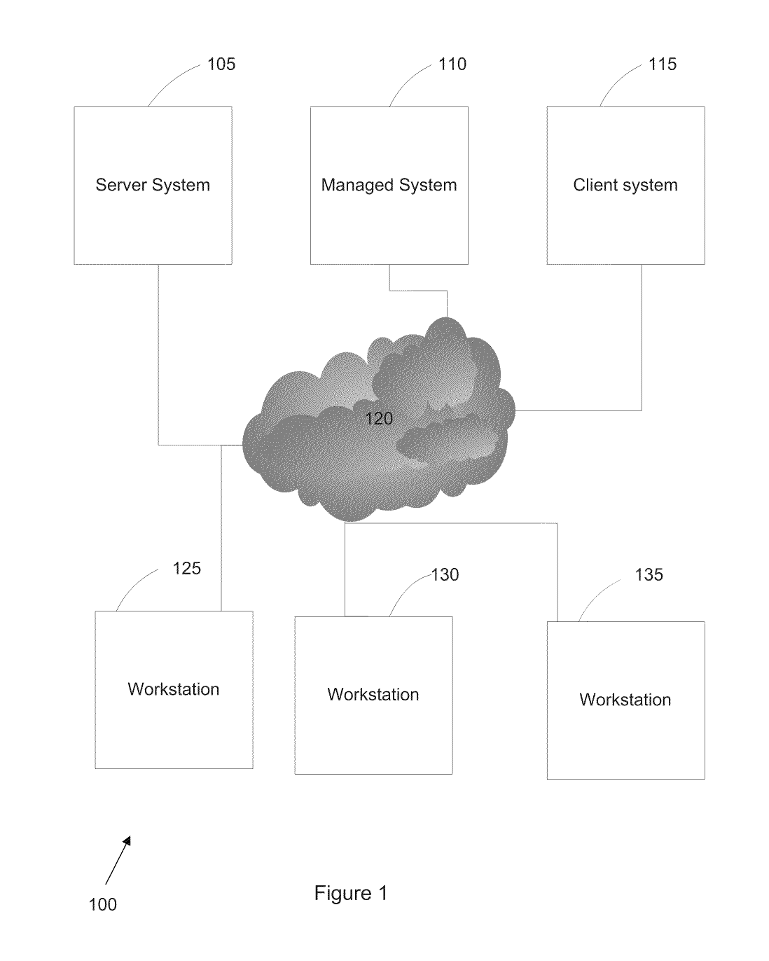

FIG. 1 is a block diagram of an operational system for managing a large distributed computing system 100. The system 100 includes a server system 105, a managed system 110, computer workstations 125, 130, 135, and a client system 115, as is well known in the art. Typically, the server system 105, managed system 110, computer workstations 125, 130, 135 and the client system 115 preferably communicate with one another over a network 120, which can be any suitable network such as a LAN, WAN, or any other network.

In one possible embodiment, the server system 105 acts as a maintenance processing system and/or a utility monitoring processing system that functions to monitor the activities and health of the components, processes, and tasks executing within the managed system 110. The managed system 110 performs the processing desired by the operators of the managed system 110. The client system 115 includes processing systems utilized by operators of the managed system 110 to view operations, maintenance and health information regarding the components, processes and tasks in the managed system 110. Furthermore, any one or more of the computer workstations 125, 130, and 135 may include processing systems utilized by operators of the managed system 110 to view operations, maintenance and health information regarding the components, processes and tasks in the managed system 110. In some embodiments, the client system 115 may, itself, be a computer workstation that is a peer of the workstations 125, 130, 135. In the embodiment shown in FIG. 1, these systems are shown to be separate processing systems. One of ordinary skill in the art will recognize that these systems may be implemented to operate on one as well as numerous hardware systems without deviating from the spirit and scope of the present invention as recited within the attached claims.

In one example embodiment, Operations Sentinel® by Unisys® provides an operational environment for managing large computing systems, such as the computing system 100 of FIG. 1. Operations Sentinel® includes a Graphical User Interface (GUI) for managing alerts in the computing system. Specifically, Operations Sentinel® provides visual alerts at the server system 105. Additionally or alternatively, one or more of the server system 105, the client system 115, and the computer workstations 125, 130, 135 includes a utility for generating audible alerts of system conditions. Thus, in this particular example, performance is enhanced with the addition of an audible alert that may gain the attention of an attendant who would not otherwise have seen a visual alert.

Continuing with the example, audible alerts can be customized for a wide variety of audiences, as different audible alerts may be appropriate for different ones of the computer workstations 125, 130, 135. It may also be the case that some alerts are directed to certain ones of the workstations and not to others. In addition, a GUI is provided in some embodiments so that commands may be sent to portions of the system generating the alert without the overhead of starting the Operations Sentinel® GUI at the server system 105 or the actual system console. Use of commands may be restricted on some ones of the workstations 125, 130, 135 according to established user permissions. While reference is made to Operations Sentinel®, it is understood that various embodiments are applicable to any monitoring system for a distributed computing system.

In contrast with prior art systems that provide only visual alerts, various embodiments provide audible alerts. Audible alerts may be generated by a speaker or other transducer controlled by a processor-based device. Some embodiments may generate an audible alert for every exception that warrants a visual alert. In other embodiments, audible alerts are reserved for more important and/or more urgent matters that require immediate attention from an attendant. Important and/or urgent alerts may include, but are not limited to, indications of crucial system processes that fail, production hosts that crash, important network nodes that do not respond, and the like.

Furthermore, in contrast to the prior art systems that provide alerts only at the server system 105, various embodiments can provide audible alerts at the computer workstations 125, 130, 135, at the client system 115, and at the server system 105 as well. The audible alerts can be generated by the same alert notification system that provides visual alerts at the server 105 or may be generated by an alert notification system that is different from the alert notification system providing visual alerts at the server system 105. In any event, it may be desirable to synchronize the visual and audible alerts in order to prevent duplication of effort.

For instance, if a visual alert at the server system 105 is acknowledged or cleared using its respective GUI, the audible alerts on each of the computer workstations 125, 130, 135 are also terminated (assuming that such audible alerts are associated with the same system exception that gave rise to the visual alert, of course). Likewise, if an interface at one of the workstations 125, 130, 135 is used to acknowledge or clear an audible alert, corresponding audible alerts at the other of the computer workstations 125, 130, 135 are terminated as well. In addition, when an audible alert at a computer workstation is cleared, any corresponding visual alerts at the server system 105 or the client system 115 are also cleared.

Such synchronization may be accomplished in computer systems using different alert notification systems to provide visual and audible alerts by allowing the different, respective alert notification systems to communicate with each other. The different alert notification systems may agree on a protocol that an alert cleared by one notification system is also cleared on the other alert notification system.

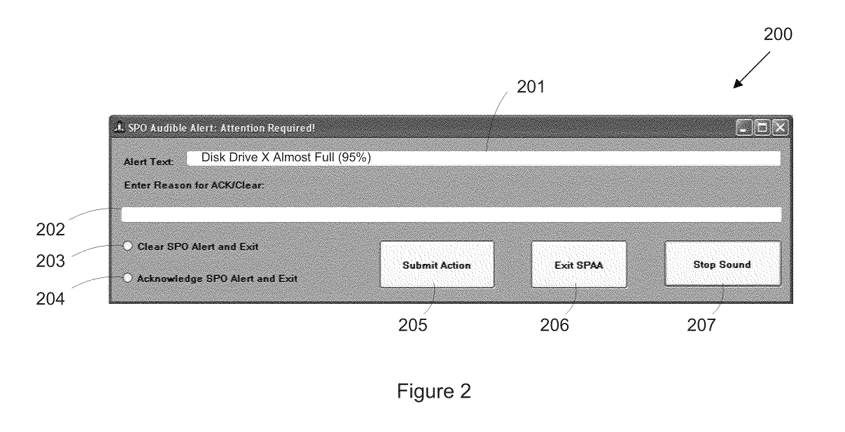

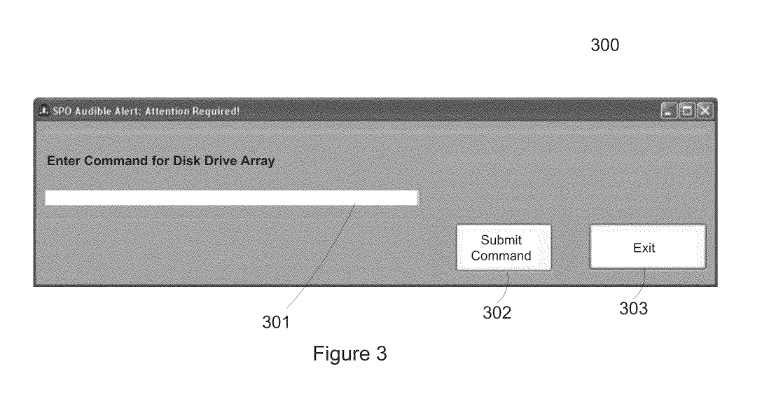

As mentioned above, a given managed system, such as managed system 110, may be monitored by different alert notification systems used for visual alerts and for audible alerts, respectively. In one example, the audible alert is played on a computer workstation (e.g., one or more of workstations 125, 130, 135) using a Microsoft Windows™ operating system, but without the Operations Sentinel® application (or other visual alert notification system) running When an audible alert is generated, the attendant may wish to send a command back to the originating system (the portion of the monitoring system 110 that is originating the underlying exception) before acknowledging or clearing the audible alert. Various embodiments provide a GUI with the audible alert that receives input from an attendant, through a command input field or other feature, to send such a command. Exemplary GUIs for use with audible alerts are described in more detail below with respect to FIGS. 2 and 3.

It is noted that a given system may assign different rights and privileges to different attendants at different computer workstations. Various embodiments customize capabilities of the GUI based on user security attributes. For instance, a command input, or other such features, may be available only for users with the proper authority. The scope of embodiments is not limited to any security protocol, as various embodiments may be adapted according to any security protocol now known or later developed.

In some embodiments, audible alerts are expressed differently on different ones of the computer workstations 125, 130, 135 though they may originate from the same system exception and correspond to a common visual alert. In other words, various embodiments tailor audible alerts in accordance with various factors, such as an intended audience, an urgency of the exception, and a noise environment. For instance, operators in a noisy data center may prefer a loud alarm, whereas a modest “ping” sound may be more appropriate for a general office area. The former alerts operators to a crucial system failure, in a busy data center, to which they must take action. The latter is perhaps more relevant to help desk users for notification purposes for less urgent issues.

In some embodiments, audible alerts are expressed differently for different types of alerts. In other words, in one instance, an audible alert of a first sound might be played and associated with a particular alert type while an audible alert of a second sound might be played and associated with a different alert type.

FIG. 2 is an illustration of an exemplary GUI 200 for use with a system providing audible alerts adapted according to one embodiment. The GUI 200 can be used by a server system, a client system, and/or a computer workstation as part of an alert notification system that provides audible alerts, such as the audible alerts described above. The GUI 200 is displayed on a computer monitor or other display device and accompanies an audible alert.

Preferably, the GUI 200 includes the field 201, which provides text associated with the audible alert. In this example, the text gives a description of the exception that caused the alert (e.g., a disk drive is nearing full capacity). In this example, an attendant may also alter the text in the field 201 if desired.

Preferably, the GUI 200 also includes the field 202, which allows a human user to enter a comment. For instance, an attendant may add a comment describing why the alert was acknowledged and/or cleared. Such comment may be processed and logged by the alert notification system to create a ticket that can be reviewed later if desired.

Preferably, the GUI 200 also includes the check boxes 203 and 204, which the attendant can use to clear and/or acknowledge the alert. The button 205 allows the attendant to submit the clear and/or acknowledge action after having checked at least one of the boxes 203, 204. The button 206 allows an attendant to exit the GUI 200 without either clearing or acknowledging the alert. The button 207 allows an attendant to stop the sound of the alert without either clearing or acknowledging the alert.

FIG. 3 is an illustration of an exemplary GUI 300 for use with a system providing audible alerts adapted according to one embodiment. The GUI 300 can be used by a server system, a client system, and/or a computer workstation as part of an alert notification system that provides audible alerts, such as the audible alerts described above. The GUI 300 is displayed on a computer monitor or other display device and accompanies an audible alert.

The GUI 300 includes a command input field 301 through which the attendant may enter a command for the portion of the system that originated the exception (in this case, the disk drive array). Once the command is entered, the attendant may select the button 302, which submits the command to the appropriate portion of the system. The button 303 allows the attendant to exit the GUI 300 without entering a command.

While the GUIs 200 and 300 are shown to include text boxes, check boxes, and buttons, it is understood that various embodiments may use any of a variety of interactive elements in a given interface for receiving input from an attendant and/or providing output to an attendant. Furthermore, while the GUIs 200 and 300 are shown separately, it is understood that features of each may be combined into a single GUI or separated out into three or more GUIs.

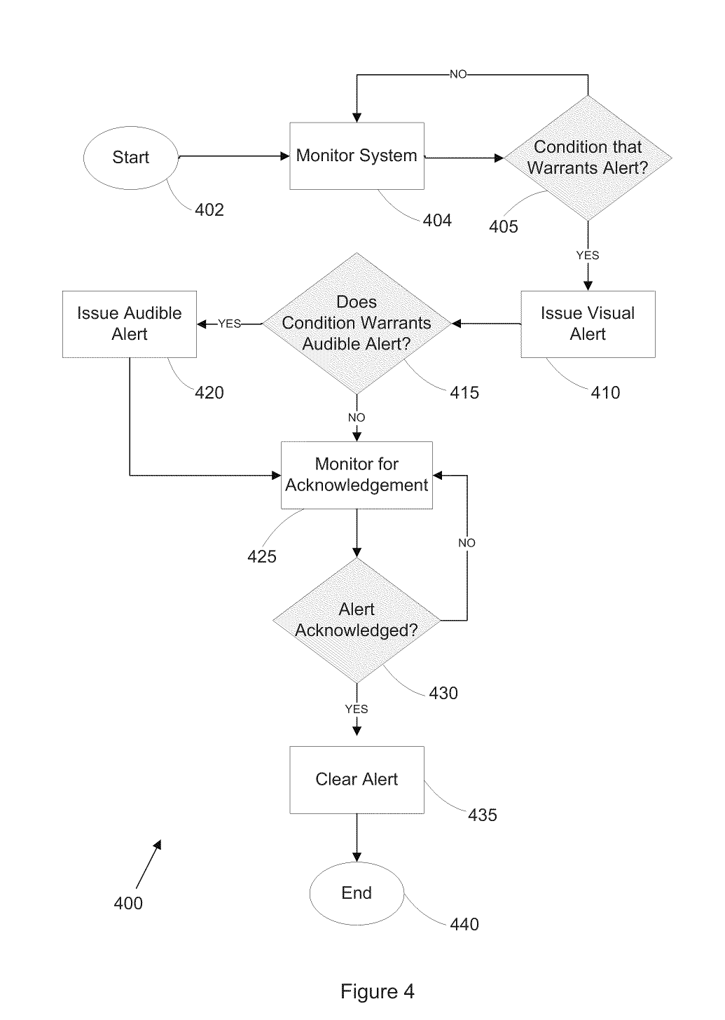

FIG. 4 is an operational flow diagram illustrating an exemplary method 400 for generating and managing alerts. The method 400 may be performed by a processor-based device running an alert notification program and monitoring a computer system. Operational flow begins at start 402. A monitor module 404 monitors the system for conditions. An alert operation 405 determines if there is a condition warranting an alert. If the alert operation 405 determines that there is not a condition warranting an alert, then operational flow branches “no” to the monitor module 404.

If the alert operation 405 determines that there is a condition warranting an alert, then operational flow branches “yes” to a visual module 410 that issues a visual alert. An audible operation 415 determines if the condition warrants an audible alert. In some embodiments, audible alerts are reserved for more urgent exceptions, though the scope of embodiments is not so limited. In fact, various embodiments may trigger an alert for any of a variety of conditions whether urgent or not.

If the audible operation 415 determines that an audible alert is warranted, then operational flow branches “yes” to an issue module 420. The issue module 420 issues an audible alert associated with the condition. The audible alert may be provided at a computer workstation, a client system, a server system, and/or other devices as may be appropriate. A acknowledgement module 425 monitors the system for acknowledgement or clearing of the alert. In some embodiments, a GUI at one or more computers and receiving user input at one or more computers through the GUI. An attendant may interact with the GUI to input information to acknowledge and/or clear the alert. Additionally, in some embodiments, the attendant may enter one or more commands through the GUI to be sent to a portion of the system that is affected by the underlying system condition and/or can be used to correct the underlying condition.

An alert operation 430 determines if the alert has been acknowledged or cleared. If the alert operation 430 determines that the alert has not been acknowledged or cleared, operational flow branches “no” to the acknowledgement module 425. If the audible alert is not cleared or acknowledged, the system continues to look for user input to clear and/or acknowledge the alert. In some instances, an alert that has not been cleared or acknowledged after a certain amount of time has passed may time out.

If the alert operation 430 determines that the alert has been acknowledged or cleared, then operational flow branches “yes” to a clear module 435. The clear module 435 clears the alert. If there is user input clearing or acknowledging the alert, then the alert is cleared and/or acknowledged at the computer wherein an attendant performed the clearing and/or acknowledging. For instance, if an attendant clears or acknowledges the alert at a particular workstation, the alert is cleared or acknowledged at that workstation. It is discerned whether the audible alert is generated at other computers. If the audible alert has been generated at other computers, then the audible alert is cleared and/or acknowledged at the other computers as well.

Operational flow ends at end 440.

Referring back to the audible operation 415, if the audible operation 415 determines that the condition does not warrant an audible alert, operational flow branches “no” to the acknowledgement module 425, and operational flow proceeds as described above.

In one particular example, a large computer system runs a first alarm notification system that provides visual alerts in addition to a second alarm notification system that provides the audible alerts. The first and second alarm notification systems are synchronized so that the visual alerts are cleared as well. In any event, then the method 400 continues to monitor the system, generating and clearing audible and visual alerts as they arise.

It is recognized that the above systems and methods operate using computer hardware and software in any of a variety of configurations. Such configurations can include computing devices, which generally include a processing device, one or more computer readable media, and a communication device. Other embodiments of a computing device are possible as well. For example, a computing device can include a user interface, an operating system, and one or more software applications. Several example computing devices include a personal computer (PC), a laptop computer, or a personal digital assistant (PDA). A computing device can also include one or more servers, one or more mass storage databases, and/or other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device.

Computer readable media includes volatile memory and non-volatile memory and can be implemented in any method or technology for the storage of information such as computer readable instructions, data structures, program modules, or other data. In certain embodiments, computer readable media is integrated as part of the processing device. In other embodiments, computer readable media is separate from or in addition to that of the processing device. Further, in general, computer readable media can be removable or non-removable. Several examples of computer readable media include, RAM, ROM, EEPROM and other flash memory technologies, CD-ROM, digital versatile disks (DVD) or other optical storage, magnetic cassettes, magnetic tape, magnetic disk storage or other magnetic storage devices, or any other medium that can be used to store desired information and that can be accessed by a computing device. In other embodiments, computer readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11 a/b/g network, radio frequency, infrared, serial, or any other data connection. In general, the communication between one or more computing devices configured with one or more communication devices is accomplished via a network such as any of a number of wireless or hardwired WAN, LAN, SAN, Internet, or other packet-based or port-based communication networks.

The above specification, examples and data provide a complete description of the manufacture and use of the composition of the invention. Since many embodiments of the invention can be made without departing from the spirit and scope of the invention, the invention resides in the claims hereinafter appended.

1. A computer program product having a computer readable medium having computer program logic recorded thereon for providing audible alerts for conditions of a distributed computer system, the computer program product comprising:
code for discerning a system condition requiring administrative attention; and
code for generating an audible alert to a first workstation of the distributed computer system in response to discerning the system condition.

2. The computer program product of claim 1 further comprising:
code for displaying a graphical user interface at the first workstation to receive input for at least one the following actions: acknowledging the audible alert and clearing the audible alert.

3. The computer program product of claim 2 further comprising:
code for sending a command to a portion of the distributed computer system affected by the system condition.

4. The computer program product of claim 1 further comprising:
code for generating the audible alert at a second workstation.

5. The computer program product of claim 4, in which the audible alert is generated with different characteristics at the second workstation than at the first workstation.

6. The computer program product of claim 1 further comprising:
code for clearing the audible alert from one or more other workstations in response to the audible alert being cleared from the first workstation; and
code for clearing at least one visual alert from at least one server in response to the audible alert being cleared for the first workstation.

7. A distributed computer system including at least one workstation and at least one component executing a system event detection program, the computer system comprising:
a first module that monitors the computer system for a system event requiring administrative attention; and
a second module that produces an audible alert of the system event on a first workstation.

8. The distributed computer system of claim 7 in which the second module produces the audible alert on a second workstation.

9. The distributed computer system of claim 8 further comprising a third module that clears the audible alert on the second workstation in response to the audible alert being cleared on the first workstation.

10. The distributed computer system of claim 8 in which the second module produces the audible alert differently on the respective first and second workstations.

11. The distributed computer system of claim 8 in which the second module tailors characteristics of the audible alert according to one or more factors.

12. The distributed computer system of claim 11 in which the factors include one or more of the following:
a noise level of an environment;
an urgency of the alert; and
an expected user.

13. The distributed computer system of claim 7 further comprising a third module that renders a graphical user interface on the first workstation for receiving input to clear the audible alert and to acknowledge the audible alert.

14. The distributed computer system of claim 7 further comprising a third module that renders a graphical user interface on the first workstation for receiving input indicating a command to be sent to a portion of the computer system affected by the system event.

15. A method for managing alerts in a distributed computer system, the method comprising:
monitoring one or more portions of the computer system for exceptions; and
upon discerning a first exception, generating an audible alert at a first workstation of the computer system.

16. The method of claim 15 further comprising:
upon discerning the first exception, generating the audible alert at a second workstation of the computer system.

17. The method of claim 16 in which the audible alert is generated differently at each of the first and second workstations.

18. The method of claim 16 further comprising:
rendering a graphical user interface on the first workstation;
receiving input through the graphical user interface indicating that the audible alert should be cleared; and
clearing the audible alert on the first and second workstations in response to the received input.

19. The method of claim 15 further comprising:
rendering a graphical user interface on the first workstation; and
receiving input through the graphical user interface indicating that the audible alert should be cleared; and
clearing a visual alert on a server in response to the received input.

20. The method of claim 15 further comprising:
rendering a graphical user interface on the first workstation
receiving input indicating a command to be sent to a portion of the computer system originating the first exception.
